(19) United States
(12) Patent Application Publication
(10) Pub. No.: US 2017/0259678 A1
(43) Pub. Date: Sep. 14, 2017

(54) ELECTRIC VEHICLE CHARGE PORT

(71) Applicant: Faraday&Future Inc., Gardena, CA (US)

(72) Inventor: Chi Hung Cao, Huntington Beach, CA (US)

(21) Appl. No.: 15/064,462

(22) Filed: Mar. 8, 2016

(51) Int. Cl. B60L 11/18

(52) U.S. Cl. CPC B60L 11/1827; B60L 11/1818

(57) ABSTRACT

Disclosed herein are movable charge port systems for electric vehicles. An electric vehicle may include a charge port capable of coupling with and receiving electrical power from a charging station. The charge port may be movably secured in a concealed position and configured to move from the concealed position to an exposed position to enable the charge port to couple with the charging station. The vehicle may include a motor configured to move the charge port from the concealed position to the exposed position and processing circuitry configured to command the motor to move the charge port. The charge port may be exposed automatically in response to detecting the presence of a charging station nearby.

### CROSS-REFERENCE TO RELATED APPLICATIONS

The present application is related to Attorney Docket No. FARA.041A, entitled “ELECTRIC VEHICLE CHARGE PORT,” filed on the same day as the present application, which is hereby expressly incorporated by reference in its entirety and for all purposes.

### TECHNICAL FIELD

The systems and methods disclosed herein are directed to electric vehicle charge ports and, more particularly, to charge ports mounted movably in the vehicle.

### BACKGROUND

Plug-in hybrids and all-electric vehicles can be propelled by one or more electric motors using electrical energy stored in one or more rechargeable batteries or another energy storage device. A charger or charging connector at a charging station may be plugged in to a charge port located on the vehicle to charge the vehicle's power source. The charge port for such plug-in hybrids and all-electric vehicles is typically externally mounted to allow easy access to the charge port and the ability to lock the passenger compartment while the vehicle is being charged. While conventional low voltage power sources may be used to charge vehicle batteries, high voltage charging stations are available to replenish electric vehicle battery charge at a faster rate than the low voltage power sources.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of the system and methods provide several advantages over traditional systems and methods.

In some embodiment, an electric vehicle with a movable charging port is described. In some implementations, a vehicle includes a charge port capable of coupling with and receiving electrical power from a charging station. The charge port may be movably secured in a concealed position and configured to move from the concealed position to an exposed position. The exposed position may enable the charge port to couple with the charging station. The vehicle may further include sensing circuitry configured to detect the charging station, at least one motor configured to move the charge port from the concealed position to the exposed position, and processing circuitry configured to command the motor to move the charge port to the exposed position based at least in part on the detection of the charging station by the sensing circuitry. A portion of the charge port may include an exterior surface that is contiguous with an exterior surface of the vehicle when the charge port is in the concealed position. The vehicle may further include a movable charge port cover configured to at least partially cover the charge port when the charge port is in the concealed position. The charge port cover may include a movable elongated portion of the exterior of the vehicle, generally extending in the lateral direction, and/or may include a movable light bar.

In another embodiment, a method of charging an electric vehicle is disclosed. The method may include receiving a charge port extension command, moving the charge port from a concealed position to an exposed position, mechanically receiving a conductive connector of a charging station at a conductive portion of the charge port, and drawing electrical current from the charging station to the charge port. Moving the charge port to the exposed position may include moving at least a portion of the charge port outward from an exterior surface of the vehicle, moving the charge port in the vertical direction, moving the charge port in the lateral direction, and/or moving the charge port in the longitudinal direction. The method may further include moving a charge port cover to expose an aperture in an exterior surface of the vehicle. Moving the charge port from a concealed position to an exposed position may include moving at least a portion of the charge port through the aperture, rotating at least a portion of the charge port about an edge of the aperture, and/or moving at least a portion of the charge port cover in a first direction and moving the charge port in a second direction that is different from the first direction. The first direction may be a direction substantially parallel to at least a portion of the exterior surface of the vehicle, and the second direction may be outward and/or substantially perpendicular to the first direction. The method may further include detecting the charging station.

In another embodiment, an electric vehicle is described. In some implementations, the vehicle includes conductive means for receiving electricity from a vehicle charging station and means for moving the conductive means from a concealed position to an exposed position, wherein moving the conductive means to the exposed position enables the conductive means to couple with a charging station. The conductive means may include an exterior surface that is substantially smooth and contiguous with an exterior surface of the vehicle when the conductive means is in the concealed position. The vehicle may further comprise a protective means configured to at least partially cover the conductive means when the conductive means is in the concealed position.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1A is a schematic representation of a movable electric vehicle charge port in a concealed position in accordance with an exemplary embodiment.

FIG. 1B is a schematic representation of a movable electric vehicle charge port in an exposed position in accordance with an exemplary embodiment.

FIG. 1C is a schematic representation of a movable electric vehicle charge port with a movable external cover in a concealed position in accordance with an exemplary embodiment.

FIG. 1D is a schematic representation of a movable electric vehicle charge port with a movable external cover in an exposed position in accordance with an exemplary embodiment.

FIG. 2 depicts an electric vehicle with a concealed charge port in accordance with an exemplary embodiment.

FIG. 2A is a perspective view of a charging station connector and a front portion of the electric vehicle of FIG. 2 with a concealed charge port in accordance with an exemplary embodiment.

FIG. 2B is a perspective view of a charging station connector and a front portion of an electric vehicle with a partially exposed charge port in accordance with an exemplary embodiment.

FIG. 2C is a perspective view of a charging station connector and a front portion of an electric vehicle with an exposed charge port in accordance with an exemplary embodiment.

FIG. 2D is an enlarged perspective view of FIG. 2C.

FIG. 3A is a side cutaway view of a charging station connector and a portion of an electric vehicle with a concealed charge port in accordance with an exemplary embodiment.

FIG. 3B is a side cutaway view of a charging station connector and a portion of an electric vehicle with a partially exposed charge port in accordance with an exemplary embodiment.

FIG. 3C is a side cutaway view of a charging station connector and a portion of an electric vehicle with an exposed charge port in accordance with an exemplary embodiment.

FIG. 3D is a side cutaway view of a charging station connector and a portion of an electric vehicle with an exposed charge port in accordance with an exemplary embodiment.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways without departing from the spirit or scope of the disclosed systems and methods.

In manual charging systems, in order to recharge the vehicle's power source the operator of the vehicle may have to handle a high-voltage cable or charging connector, which may be dangerous, especially during conditions such as darkness or inclement weather. Additionally, electric vehicle charge ports are typically located along the side of the vehicle similar to gas tank inlets on combustion-engine-powered vehicles. However, in parking garages, both residential and public, it may not be practical for a charging station to be located along the side of a vehicle, particularly in parking areas designated for multiple electric vehicles where each vehicle may require a charging station.

Charge ports often include a cover. Such covers commonly include a hinged door that opens to reveal the charge port. Covers may be required to be manually opened and/or closed by a person. Such an operation may be time consuming and/or inconvenient, especially during inclement weather.

The aforementioned problems, among others, are addressed in some embodiments by the charge port disclosed herein that can be movably mounted on or within the vehicle. The movable nature of the charge port can facilitate automated coupling with a charger of a charging station for replenishing the electric vehicle battery. During driving or non-charging parking of the vehicle a charge port as disclosed herein can be concealed by the exterior or body of the vehicle. In a pre-charging mode or charging mode the charge port can be moved from a stored position to a charging position. In the charging position, the charge port may be exposed and available for coupling with a charging connector at a charging station. In some aspects, when the charge port is in the stored position, the charge port may not be visible. That is to say, the charge port may be formed such that at least one exterior surface of the charge port substantially matches the curvature of an exterior surface of the vehicle. The charge port may then move from the stored position to a charging position where it can be coupled to a charging station. Thus, the charge port may move from a visible position to a hidden position. In some aspects, a movable charge port may be aesthetically pleasing.

In some implementations, the charge port is mounted in a front-facing portion of the vehicle. Front-facing mounting of the charge port can facilitate connection with a charging station positioned in front of the vehicle when the vehicle is parked. Such front-mounted charge ports may be contained within a housing that is flexibly mounted within the vehicle such that the housing is movable during low-impact collisions, for example to absorb or cushion impact in one or more directions during collision between the vehicle front and another vehicle or other object.

To assist in the description of various components of the vehicle charge port systems, the following coordinate terms are used throughout the figures. An “outward direction” refers to a direction substantially normal to an exterior surface of a vehicle, and refers to motion from the interior of the vehicle toward and beyond the exterior surface of the vehicle. An “inward direction” refers to a direction substantially parallel to the outward direction, but in the opposite direction, toward the interior of the vehicle. A longitudinal direction generally extends along the length of a vehicle from the front to rear (e.g. from the front bumper to the rear bumper). A lateral direction is perpendicular to the longitudinal direction and generally extends along the width of a vehicle from the side to side. A vertical direction is perpendicular to both the longitudinal and lateral direction and generally extends from the bottom of the car to the top (e.g. from the tires to the roof).

Some implementations relate to devices, systems, and methods for moving a charge port with respect to a vehicle. In some aspects, the charge port is configured to move with respect to at least one exterior surface of the vehicle. For example, the charge port may move longitudinally, laterally, or vertically with respect to the vehicle. Thus, in some aspects, the charge port is configured to move laterally out from one or more sides of the vehicle. For example, a charge port may be located the side of the vehicle, in a location that is similar to the location of a traditional gas tank inlet, and configured to move laterally outward from the side of the vehicle. In another example, the charge port is configured to move longitudinally, outward from the front and/or rear of the vehicle. In another example, the charge port is configured to move vertically, outward from the top and/or bottom of the vehicle. For example, the charge port may move down from the undercarriage of the vehicle. The charge port may be configured to move in one or more directions. For example, the charge port may be configured to move outward in a longitudinal direction and upward in a vertical direction. The charge ports may also be configured to move in the opposite direction when returning to a stored position.

In some aspects, a charge port opening may be partially and/or completely concealed by a charge port cover. The cover may be configured to automatically open and/or closed and the charge port may be configured to move through the opening that was concealed by the cover.

Embodiments of the disclosure also relate to systems and techniques for flexibly and movably mounting charge ports in front-facing portions of an electric vehicle. When not in use the charge port can be concealed by the body of the vehicle. Concealing the charge port in the body of the vehicle when not in use can protect the charge port from damage, and can prevent direct external connection to the electrical systems of the vehicle. In pre-charging or charging scenarios the charge port can be automatically moved to a charging position where it is exposed through the vehicle body and thus available for coupling with a charging connector at a charging station. Accordingly, the charge port can be automatically movable between the non-charging concealed position and charging exposed position, for example by one or more motors and corresponding mechanical systems and software systems designed to facilitate movement between positions.

Further, some charge ports described herein can be mounted in a front-facing portion of the vehicle to facilitate connection with a charging station positioned in front of the vehicle (that is, in view of an operator of the vehicle) when parked and in need of replenishment of stored battery charge. Such front-mounted charge ports may be flexibly mounted within the vehicle such that they are movable during low-impact collisions, for example by one or more springs or other shock-absorbing structures. For example, a front-mounted charge port may be contained within a housing that is flexibly mounted within the vehicle such that the housing is movable during low-impact collisions, for example to comply with standards for front-impact collisions and/or to absorb or cushion impact during collision between the vehicle front and another vehicle or other object.

Due to the movable nature of the charge port, the power cable or cables connecting the charge port to the battery bank or other power source of the vehicle can be movably mounted to absorb oscillations resulting from movement of the charge port. For example, the cables can be mounted within a bushing or other isolating mechanical device designed to reduce vibrations. The bushing can be movably mounted within an elongated slot in a surface of or adjacent to the charge port housing. In some implementations, the bushing can be a rubber bushing having a number of apertures corresponding to number of cables passing through the bushing. The elongated slot can have a similar width to the diameter or width of the bushing but can have a length greater than the diameter or length of the bushing, thereby allowing movement of the bushing through the length of the elongated slot. Some implementations of the elongated slot may be formed along a curve to allow for both vertical and horizontal displacement of the bushing. The bushing may be spring-loaded to maintain a default position in the absence of forces due to movement of the charge port housing.

As used herein, the term “electric vehicle” can refer to any vehicle that is partly or entirely operated based on stored electric power, such as a pure electric vehicle, plug-in hybrid electric vehicle, or the like. Such vehicles can include, for example, road vehicles (cars, trucks, motorcycles, buses, etc.), rail vehicles, underwater vessels, electric aircraft, and electric spacecraft.

Various embodiments will be described below in conjunction with the drawings for purposes of illustration. It should be appreciated that many other implementations of the disclosed concepts are possible, and various advantages can be achieved with the disclosed implementations.

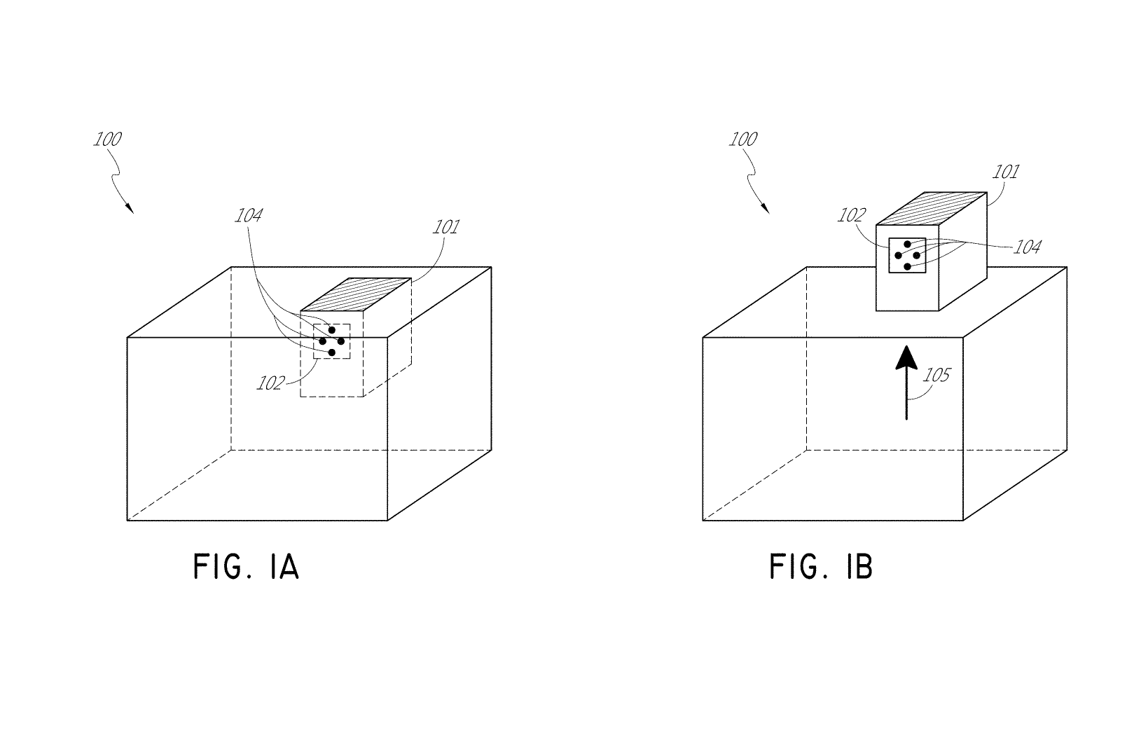

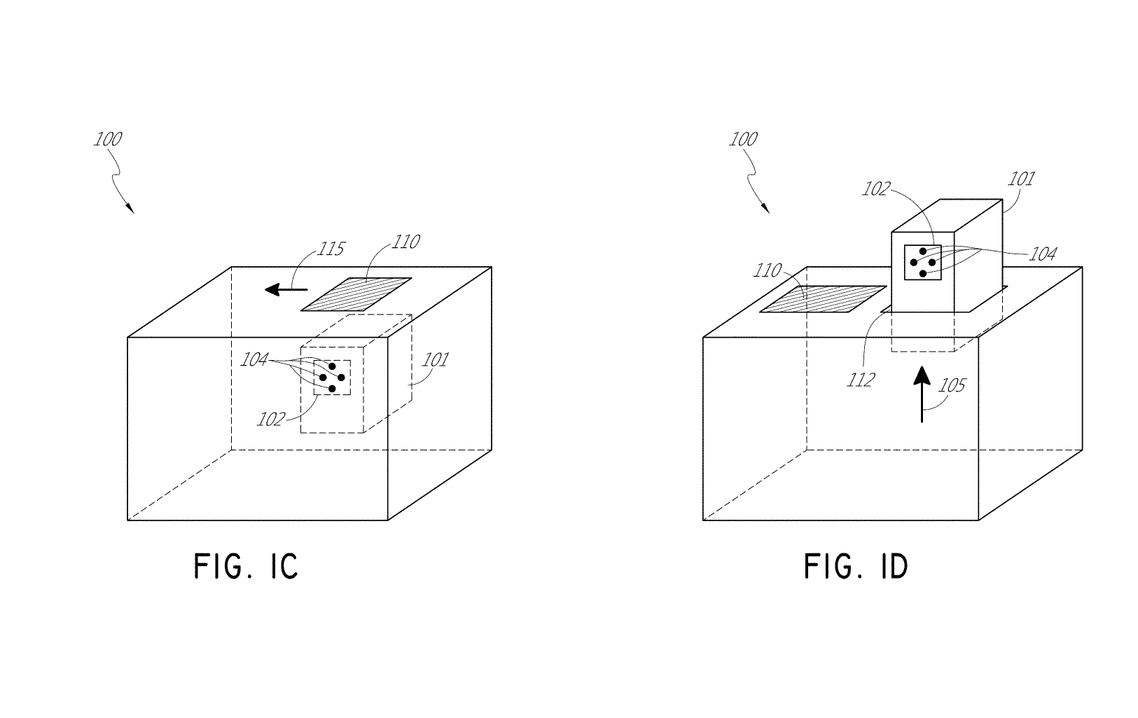

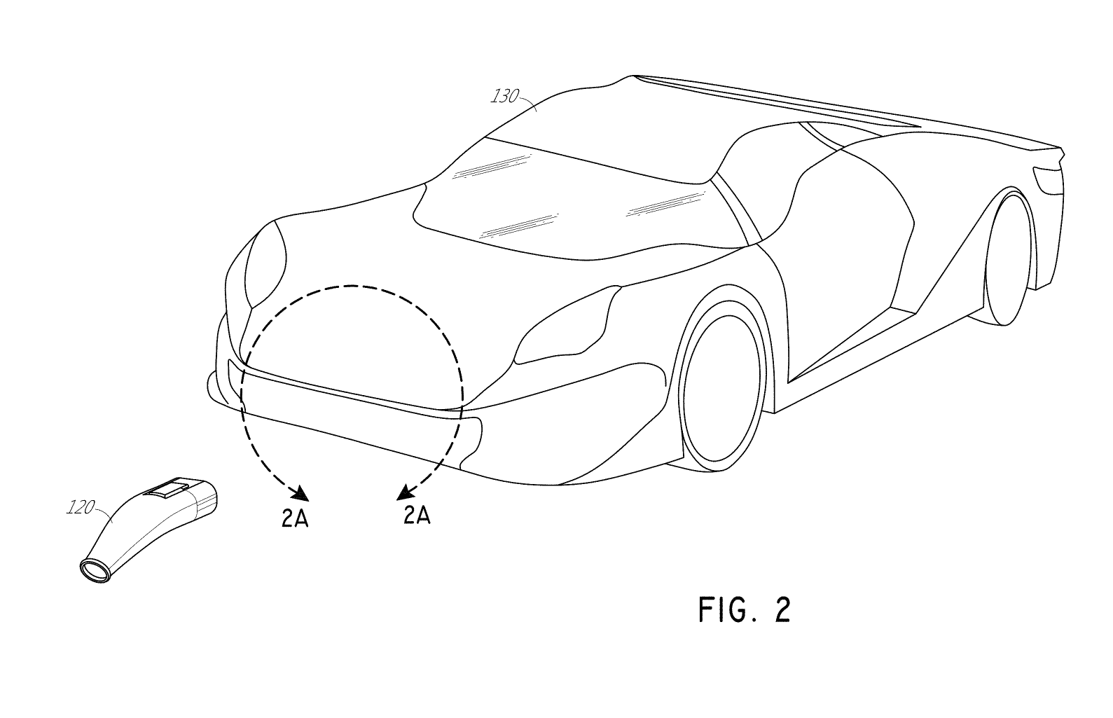

FIGS. 1A-1D generally depict movable electric vehicle charge port systems in their concealed and exposed positions. Referring to all four of FIGS. 1A-1D, a charge port 101 is disposed in the interior of a portion 100 of an electric vehicle. The charge port 101 may comprise a charging interface 102 configured to receive and/or couple with a charging connector 120 (not shown) of a charging station. The charging interface 102 may comprise a plurality of conductive pins 104 capable of transferring power from a high voltage source to battery charging circuitry connected to one or more batteries of the electric vehicle. The embodiments depicted in FIGS. 1C and 1D further comprise a charge port cover 110 configured to partially or completely cover the charge port 101 when the charge port 101 is in the concealed position.

FIGS. 1A and 1C depict embodiments of a charge port system in a concealed, or retracted, position, while FIGS. 1B and 1D depict embodiments of a charge port system in an exposed, deployed, pre-charging, or charging position. The charge port 101 may extend from the concealed position to the exposed position by moving in an outward direction 105 toward the exterior of the vehicle. In embodiments with a movable exterior cover 110, the cover 110 may move in a first direction 115 to uncover a charge port aperture 112 through which the charge port 101 may extend. Such a cover may move in one or more of the lateral, longitudinal, or vertical directions. Such covers may move inward or outward with respect to the vehicle.

The charge port may be located on any portion 100 of an electric vehicle. For example, the portion 100 may be a section of the front or rear end of the vehicle. Within the front or rear end of the vehicle, the charge port may be located along an upper portion of the vehicle, a side-facing portion of the vehicle, or a bottom portion of the vehicle. In some embodiments, the charge port may extend outward from the chassis or undercarriage of the vehicle. In some aspects the charge port is located in the front or rear bumper or just behind the front bumper or just in front of the rear bumper. Locating a charge port 101 near the front end of a vehicle may be desirable because the portion 100 of the vehicle containing the charge port 101 may be visible to the driver, allowing the driver to accurately position the charge port 101 in close proximity to a charging station. Moreover, a charge port 101 located at the front of a vehicle may permit a vehicle to pull forward into a parking space and utilize a charging station located at the interior end of the parking space, such as on an adjacent wall or sidewalk. A charge port in the rear of the vehicle may be similarly utilized where a diver prefers backing into driveways, parking stalls, and/or garages.

In embodiments comprising a charge port cover 110, the charge port cover 110 may be any portion of the exterior body surface of the vehicle. The charge port cover 110 may comprise a section of the exterior layer of the vehicle, such as a painted metal, plastic, or composite material. Alternatively, the charge port cover 110 may comprise additional components. For example, the charge port cover 110 may comprise a movably mounted headlight, taillight, or other exterior lighting component, a grill or other air intake structure, a license plate mount, or other exterior vehicle component. The cover may include a hinged door, a rolling door, a slidable cover, and the like. In some aspects, an exterior portion of the movable charge port 101 may comprise a section of the exterior layer of the vehicle, such as a painted metal, plastic, or composite material.

The charge port and/or charge port cover may be coupled to one or more motors, actuators, servos, hydraulics, pneumatics or the like. Such mechanisms may be electrically powered and may be coupled directly or indirectly coupled to the charge port and/or charge port cover to facilitate the movement of the charge port and/or charge port cover form a concealed position to an exposed position. Additionally and/or alternatively, the charge port and/or charge port cover may be coupled to a spring and/or actuator that does not require electrical power. Such mechanisms may be able to move the charging port and/or charge port cover even if the vehicle does not have enough stored energy to power the electronic mechanism.

Continuing with FIGS. 1A-1D, in various embodiments the charge port cover 110 moves in a first direction 115 and the charge port 101 moves in a second direction 105. Although FIGS. 1B, 1C, and 1D depict the first direction 115 as a lateral direction and the second direction 105 as a vertical direction, other combinations are possible. The first direction 115 and the second direction 105 may be substantially the same direction, or may be different directions. For example, in addition to the directions depicted, the charge port cover 110 may move in a vertically outward direction to allow the charge port 101 to move in a vertically outward direction as well, either simultaneously or after the cover 110 moves in a vertically outward direction. In other embodiments, the cover 110 may move in a vertically inward direction, and a charge port 101 may extend outward in a lateral and/or longitudinal direction to be accessible through the aperture 112. In some embodiments, the cover 110 may swing open about a fixed point or axis in a combination of lateral, longitudinal, and vertical outward or inward motion to expose the aperture 112 and charge port 101.

The charge port 101 may also move in a combination of longitudinal, lateral, and/or vertical motions. For example, the charge port 101 may first move in a lateral direction to a position adjacent to the aperture 112, then move in a vertically outward direction to be further exposed from the exterior of the vehicle. The charge port 101 may move in a single swinging motion about a fixed point or axis in a combination of lateral, longitudinal, and vertical outward motions to be exposed from the exterior of the vehicle. Rotational motion may further be included in the motion of the charge port 101 so as to facilitate efficient coupling with a charging station connector.

In embodiments without a cover 110, the charge port 101 may form a portion of the exterior surface of the vehicle. For example, the outward-facing surface of the charge port 101 may comprise a material consistent with the surrounding portion of the exterior of the vehicle, such as painted metal, plastic, or composite material. In such embodiments, any of the various types of motion described above may be employed to move the charge port 101 from a concealed position to an exposed position at the exterior of the vehicle.

Continuing with FIGS. 1A-1D, the charge port 101 may extend from a concealed position to an exposed position in response to a user command. For example, a user may command the charge port 101 to extend by pressing a button or similar switch located at the interior or exterior of the vehicle, pressing a button of a remote control device, sending a wireless request via a smartphone or other personal electronic device, activating a biometric recognition device such as fingerprint or voice recognition, or by manually extending the charge port into the exposed position. In some embodiments, the charge port 101 may be configured to extend in response to the user manually opening a charge port cover 110.

In some embodiments, the charge port 101 may be configured to extend automatically based on any of various predetermined signals. For example, the charge port 101 may be configured to extend automatically when the vehicle parks in the vicinity of a compatible charging station. A charging station may emit a signal, such as electromagnetic radiation, infrared light, ultrasound, near-field communication, Bluetooth, Wi-Fi, or any other form of communication that can be detected by the vehicle and/or the charge port 101. In some embodiments, a charging station may have a handheld or automatic charging connector configured to connect mechanically and electronically with the charge port 101. In such embodiments, the charging connector may emit any of the wireless communications listed above, and the charge port 101 may be configured to extend to an exposed position when a charging connector is detected in close proximity to the charge port 101. Similarly, the vehicle may use any of the above techniques or combinations thereof to determine when the vehicle is parked in the vicinity of a compatible charging station.

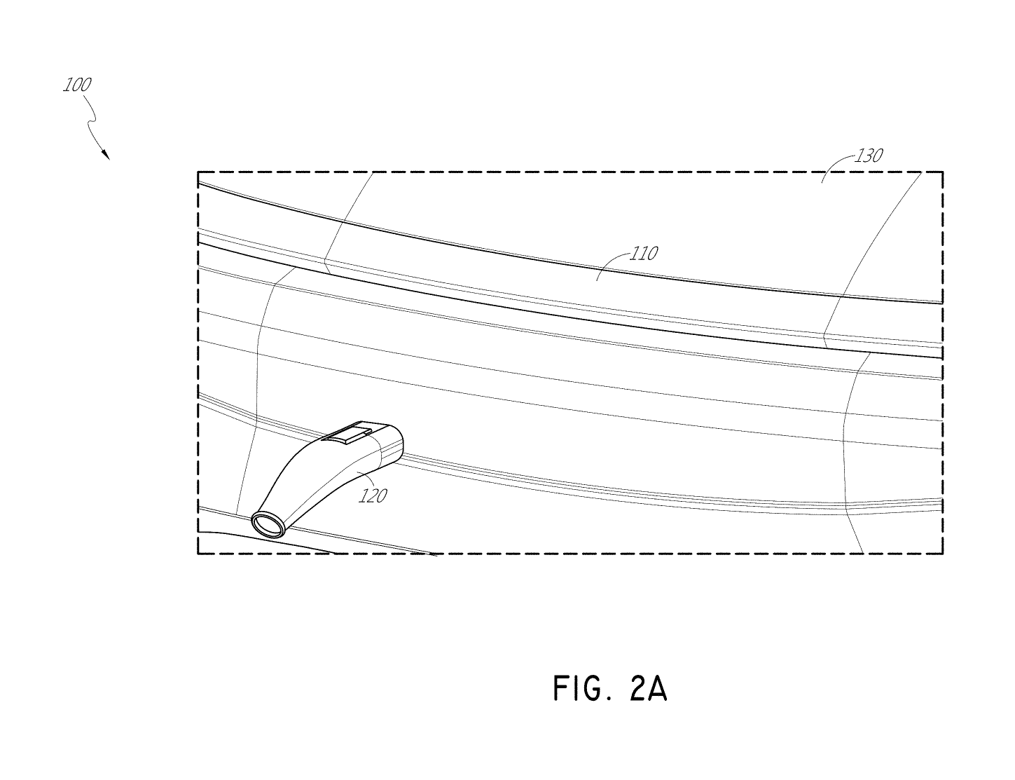

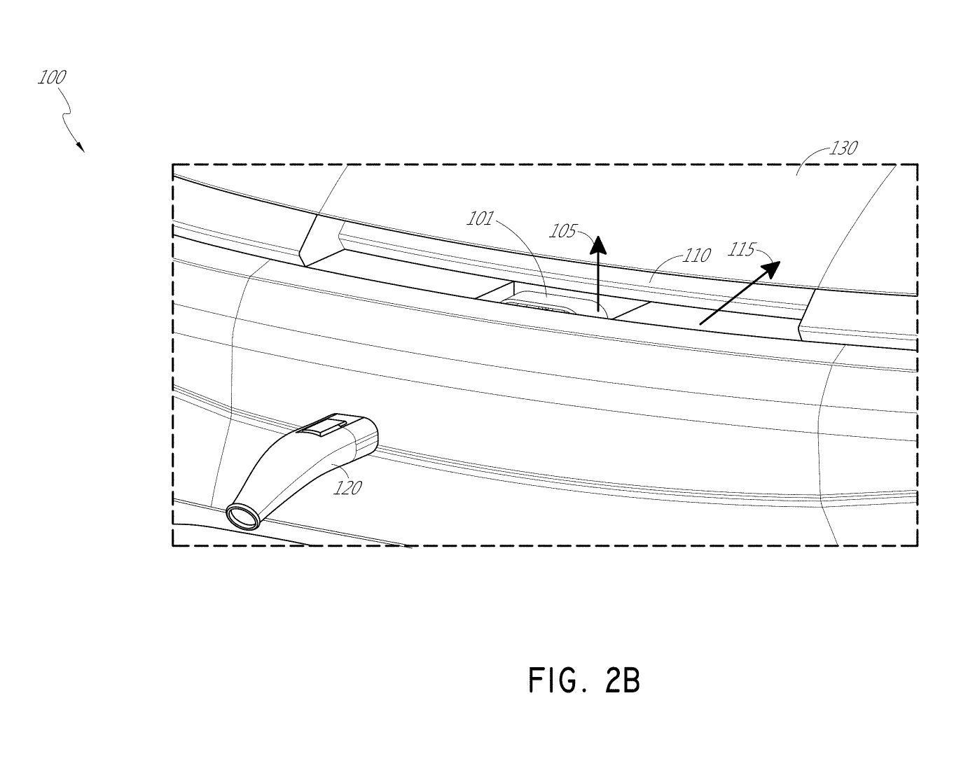

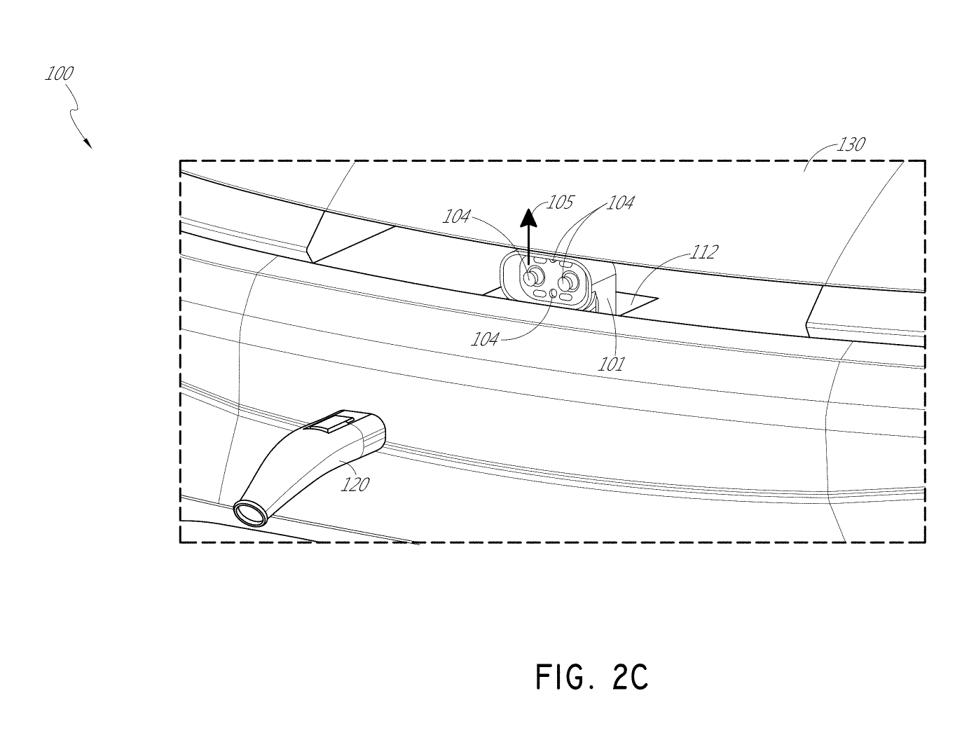

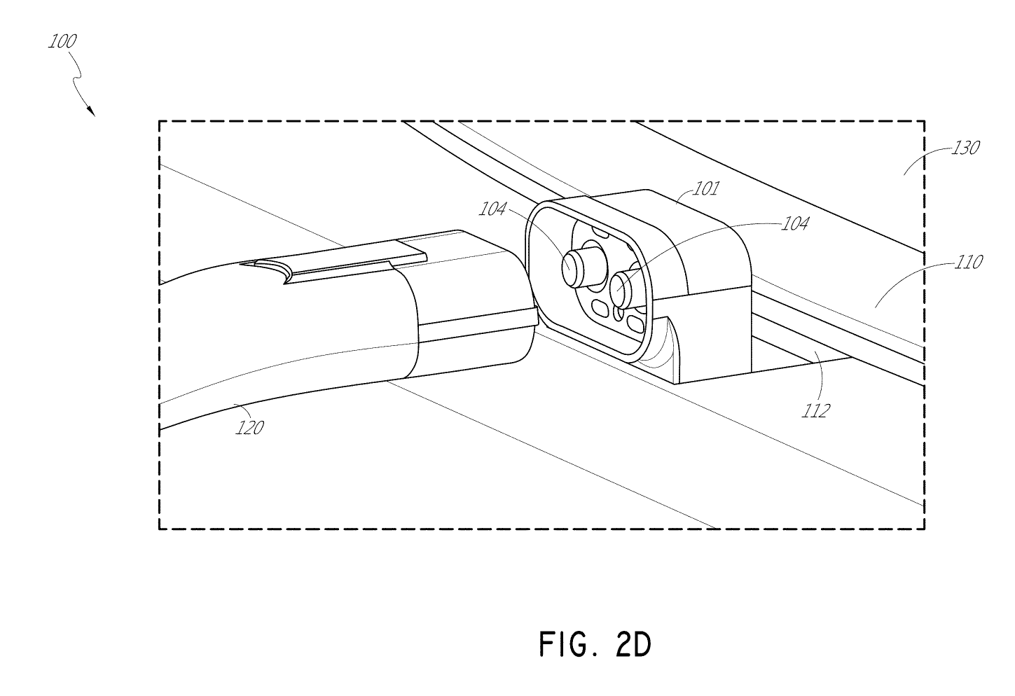

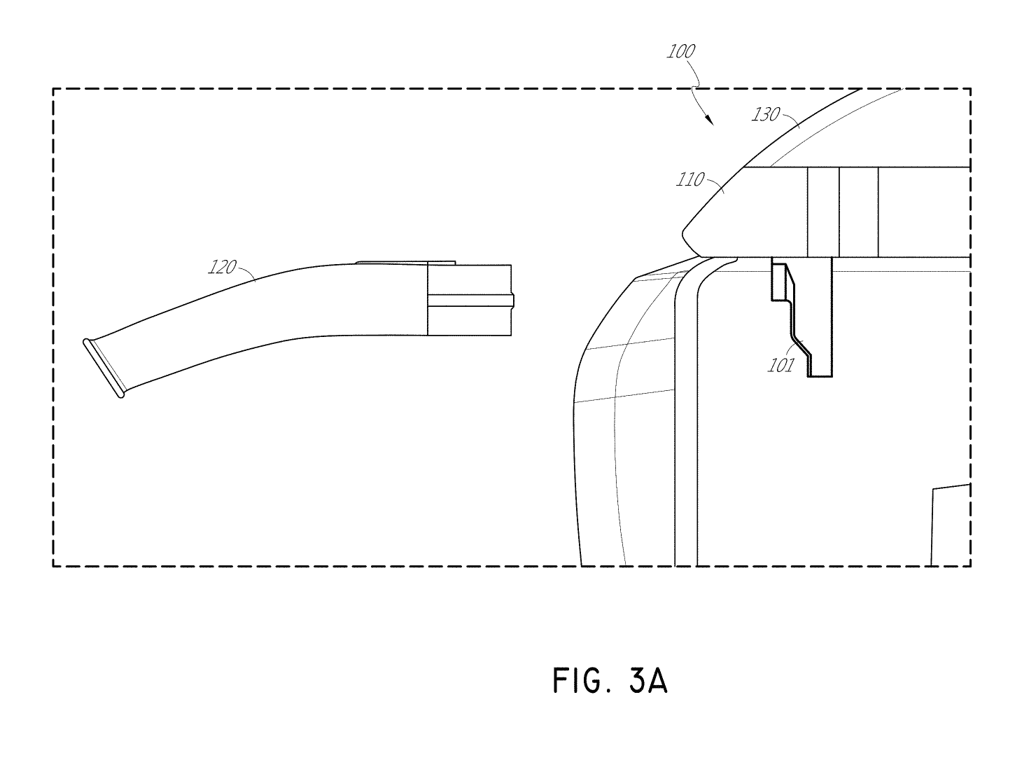

FIG. 2 depicts a charging station connector 120 and a vehicle 130 with a movable charge port concealed in a front portion of the vehicle 130, in accordance with an exemplary embodiment. As described above, a charge port may alternatively be concealed in a rear, side, upper, lower, or other portion of a vehicle 130. FIGS. 2A-2D depict a charging station connector 120 and a portion 100 of a vehicle 130 as depicted in FIG. 2 with a movable charge port 101 and charge port cover 110 in accordance with an exemplary embodiment. FIG. 2A depicts the charge port 101 in a concealed position. FIG. 2C depicts the charge port 101 in an exposed position. FIG. 2B depicts an intermediate configuration with the charge port cover 110 in a retracted position to allow the extension of the charge port, but with the charge port 101 still in a concealed position. FIG. 2D is an enlarged view of the system in the exposed position of FIG. 2C, with the charging connector 120 in close proximity to the charge port 101.

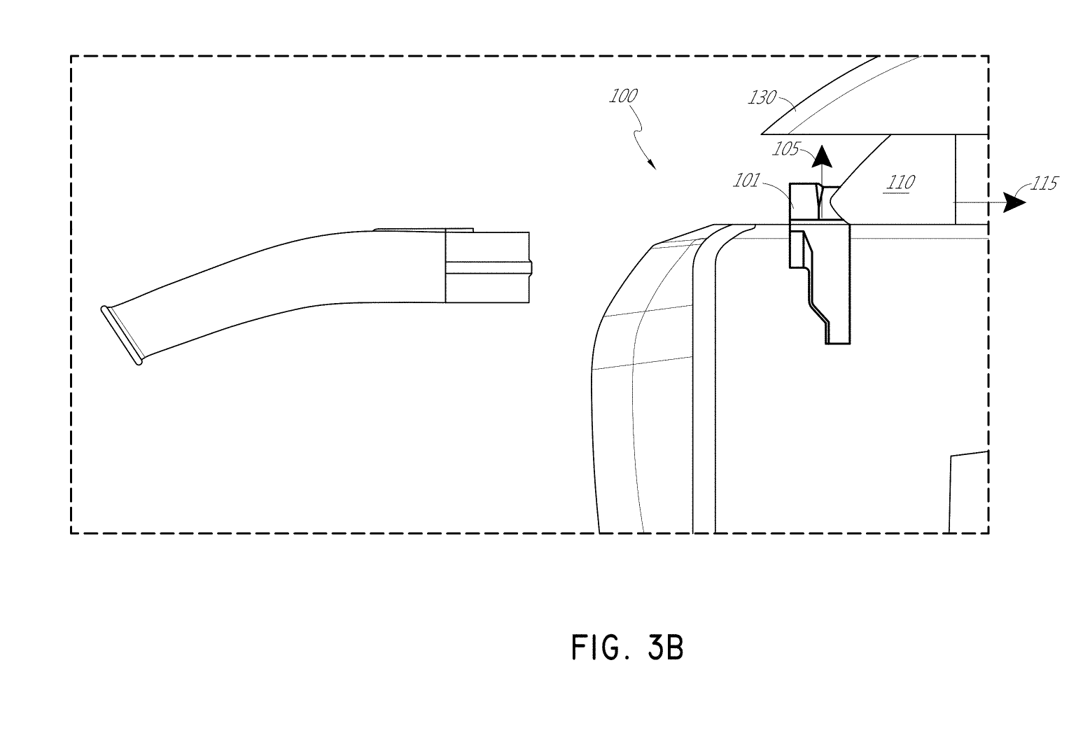

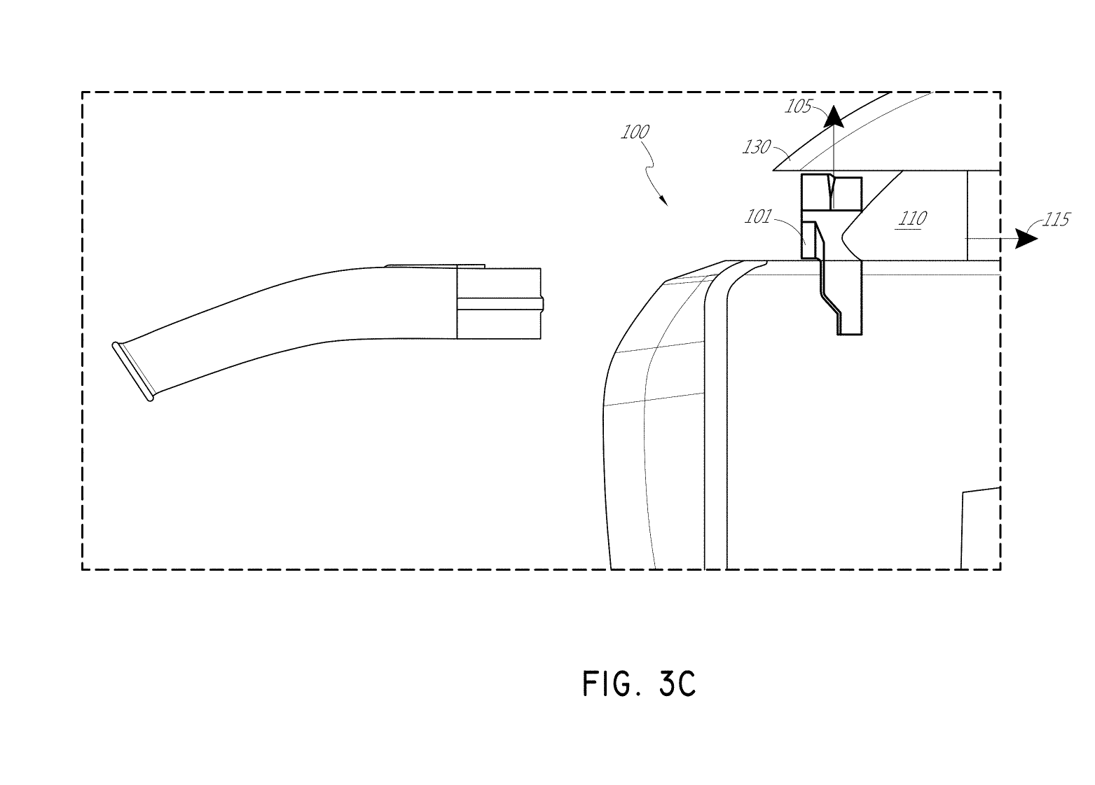

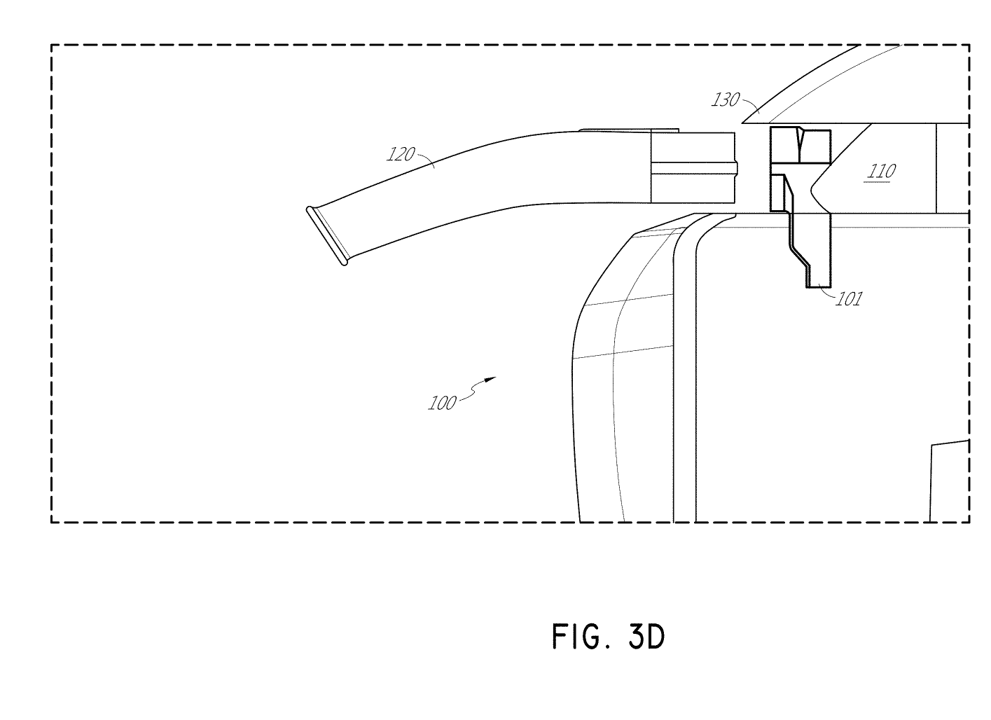

In the exemplary embodiment depicted, the charge port 101 is located in a front portion 100 of the vehicle. In FIG. 2A, the charge port 101 is not visible, as it is covered by the charge port cover 110. Here, the charge port cover 110 is an elongated headlight structure. However, any structure on the car may be utilized. In some aspects, a portion of the front or rear bumper may move in the vertical and/or longitudinal direction. The headlight structure 110 of FIGS. 2-3 is movably mounted in its ordinary operating position at the exterior of the vehicle. The headlight structure 110 may slide in a first direction 115. Here, the first direction 115 is a longitudinal and inward direction, toward the interior of the vehicle. Comparing FIG. 2C with FIGS. 2A and 2B, the motion of the headlight structure 110 along the first direction 115 exposes the charge port aperture 112, and the charge port may extend along the second direction 105 through the aperture 112. Here, the second direction 105 is a vertically outward direction. In this embodiment, the conductive pins 104 face away from the font of the vehicle to facilitate coupling with the charging port connector 120.

As described above with reference to FIGS. 1A-1D, the extension of the charge port 101 from the concealed position of FIG. 2A to the exposed position of FIG. 2C may occur based on a user command, or may occur automatically. In the case of automatic extension, the proximity of the charging station connector 120 to the charging port portion 100 of the vehicle may have initiated the automatic extension process.

FIGS. 3A-3D depict a side cutaway view of a charging station connector 120 and a portion 100 of a vehicle with a movable charge port 101 and charge port cover 110 in accordance with an exemplary embodiment consistent with the embodiment of FIGS. 2-2D. In FIG. 3A, the charge port 101 is concealed within the interior of the vehicle, adjacent to the headlight structure 110. Initially, the headlight structure 110 is located in its operating location at the exterior of the vehicle. When the charging station connector 120 is moved to a location near the charge port 101, it may emit a signal as described above, which may be detected by circuitry (not shown) within the vehicle. Detection of a nearby connector 120 may initiate the charge port opening sequence.

In FIG. 3B, the headlight structure or light-bar 110 has moved inward along the first direction 115 to a retracted position. As shown, the headlight structure or light-bar 110 may be elongated in a generally lateral direction. In some aspects, the headlight structure or light-bar 110 may be shaped to substantially correspond to the shape of the bumper and/or hood of the vehicle. The charge port 101 has moved vertically outward along the second direction 105 into the space formerly occupied by the headlight structure, as shown in FIG. 3A. The charge port 101 may continue moving along the second direction 105 into its exposed position, as depicted in FIG. 3C. Once the charge port 101 is in the exposed position, the connector 120 may be moved into position for coupling as shown in FIG. 3D. In some embodiments, the connector 120 may be a handheld device capable of manually coupled to the charge port 101 by a user. In some embodiments, the charging station (not shown) may be configured to autonomously move the connector 120 to couple with the charge port 101. Correct alignment of the connector 120 with the charge port 101 may be achieved by laser, ultrasound, visual, magnetic, or other automatic alignment means.

Following the coupling of the connector 120 with the charge port 101, current may flow from the charging station (not shown) to one or more batteries of the vehicle through the charge port 101. Charging may continue until the batteries are partially or fully charged. When sufficient charging has occurred, or when it is desired to disconnect the vehicle from the charging station for any other reason, the connector 120 may be uncoupled from the charge port 101, either manually or automatically. After uncoupling the connector 120 from the charge port 101, the extension process described in the various embodiments above may be reversed so as to retract the charge port 101 from an exposed position to a concealed position.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. An electric vehicle with a movable charging port comprising:
a charge port capable of coupling with and receiving electrical power from a charging station, the charge port movably secured in a concealed position and configured to move from the concealed position to an exposed position, the exposed position enabling the charge port to couple with the charging station.

2. The electric vehicle of claim 1, further comprising:
sensing circuitry configured to detect the charging station;
at least one motor configured to move the charge port from the concealed position to the exposed position; and
processing circuitry configured to command the motor to move the charge port to the exposed position based at least in part on the detection of the charging station by the sensing circuitry.

3. The electric vehicle of claim 1, wherein a portion of the charge port includes an exterior surface that is contiguous with an exterior surface of the vehicle when the charge port is in the concealed position.

4. The electric vehicle of claim 1, further comprising a movable charge port cover configured to at least partially cover the charge port when the charge port is in the concealed position.

5. The electric vehicle of claim 4, wherein the charge port cover includes a movable elongated portion of the exterior of the vehicle, generally extending in the lateral direction.

6. The electric vehicle of claim 5, wherein the charge port cover includes a movable light bar.

7. A method of charging an electric vehicle, the method comprising:
receiving a charge port extension command;
moving the charge port from a concealed position to an exposed position;
mechanically receiving a conductive connector of a charging station at a conductive portion of the charge port; and
drawing electrical current from the charging station to the charge port.

8. The method of claim 7, wherein moving the charge port to the exposed position comprises moving at least a portion of the charge port outward from an exterior surface of the vehicle.

9. The method of claim 8, wherein moving the charge port to the exposed position comprises moving the charge port in the vertical direction.

10. The method of claim 8, wherein moving the charge port to the exposed position comprises moving the charge port in the lateral direction.

11. The method of claim 8, wherein moving the charge port to the exposed position comprises moving the charge port in the longitudinal direction.

12. The method of claim 7, further comprising moving a charge port cover to expose an aperture in an exterior surface of the vehicle.

13. The method of claim 12, wherein moving the charge port from a concealed position to an exposed position includes moving at least a portion of the charge port through the aperture.

14. The method of claim 13, wherein moving the charge port from a concealed position to an exposed position includes rotating at least a portion of the charge port about an edge of the aperture.

15. The method of claim 12, wherein moving the charge port from a concealed position to an exposed position includes moving at least a portion of the charge port cover in a first direction and moving the charge port in a second direction that is different from the first direction.

16. The method of claim 15, wherein the first direction is a direction substantially parallel to at least a portion of the exterior surface of the vehicle and the second direction is outward and substantially perpendicular to the first direction.

17. The method of claim 7, further comprising, detecting the charging station.

18. An electric vehicle comprising:
conductive means for receiving electricity from a vehicle charging station; and
means for moving the conductive means from a concealed position to an exposed position, wherein moving the conductive means to the exposed position enables the conductive means to couple with a charging station.

19. The electric vehicle of claim 18, wherein the conductive means includes an exterior surface that is substantially smooth and contiguous with an exterior surface of the vehicle when the conductive means is in the concealed position.

20. The electric vehicle of claim 18, further comprising a protective means configured to at least partially cover the conductive means when the conductive means is in the concealed position.
